(19) United States
(12) Patent Application Publication
(10) Pub. No.: US 2011/0047318 A1
(43) Pub. Date: Feb. 24, 2011

(54) Reducing capacitive load in a large memory array

(76) Inventor: Robert W. Dmitroca, Vancouver (CA)

Correspondence Address: INTEL CORPORATION;c/o CPA Global, P.O. BOX 52050, MINNEAPOLIS, MN, 55402, US

(21) Appl. No.: 12/583,340

(22) Filed: Aug. 19, 2009

(51) Int. Cl. G06F 12/00; G06F 12/02

(52) U.S. Cl. 711/103; 711/E12.001; 711/E12.008

(57) ABSTRACT

In various embodiments, field-effect transistors (FETs) or other high-resistance electronic switches may be used to take a large group of parallel-connected memory devices and separate them into smaller groups of parallel-connected devices, so that the signal lines in each group may be electrically isolated from the signals lines in the other groups. In this way, when one memory device is selected for an operation, only the other memory devices in that group will contribute to the capacitive load on the signal lines to the memory controller, while the capacitive load from the memory devices in the other groups will be electrically isolated by having their associated FETs turned off. The resultant reduced capacitive load may permit higher operating speeds and higher data rates for read or write operations with the memory devices.

### BACKGROUND

Large arrays of NAND flash devices are required to construct Solid State Drives (SSD's), storage devices that use semiconductor-based storage rather than magnetic recording on a rotating disk. In order to have a reasonable number of pins on the controller used on the SSD, many NAND devices are typically bussed together (connected in parallel to the same lines) to create the desired storage capacity. These bussed devices may form a ‘channel’. When bussing many devices together in this manner, the capacitive loads of all the devices tied to a single line sum to produce the resulting capacitive load seen by any device driving a signal on that line. Since a high capacitive load increases the amount of time required to transition a digital signal from one state to another, this bussing has the effect of limiting the frequency at which each line may operate, thereby limiting the effective data rate of the SSD.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a single signal line driving multiple devices that are divided into groups, according to an embodiment of the invention.

FIG. 2 shows a block diagram of a storage device, according to an embodiment of the invention.

FIG. 3 shows a block diagram of a computer system, according to an embodiment of the invention.

FIG. 4 shows a flow diagram of a method of operating a storage device, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a computer-readable medium, which may be read and executed by one or more processors to enable performance of the operations described herein. A computer-readable medium may include any mechanism for storing information in a form readable by one or more computers. For example, a computer-readable medium may include a tangible storage medium, such as but not limited to read only memory (ROM); random access memory (RAM); magnetic disk storage media; optical storage media; a flash memory device, etc.

In a storage device that contains multiple memory devices connected together in parallel, various embodiments of the invention use electronic switches to electrically isolate groups of the memory devices from each other, to reduce the capacitive loading that occurs on any individual signal line. For example, if twenty memory devices are coupled in parallel to a single memory controller in a conventional storage device, each signal line may have twenty times the amount of capacitive loading that a single memory device would produce on that signal line, and this excessive loading may significantly reduce the speed at which the data may be conveyed over that signal line. By grouping these twenty memory devices into five groups of four devices each, and using an electronic switch to isolate the signal line for one group from the same signal line for the other four groups, capacitive loading may be reduced to four times the capacitive loading that a single memory device would produce, thus decreasing the potential rise and fall times of a digital signal on the line, and effectively increasing the speed at which data may be conveyed over that line.

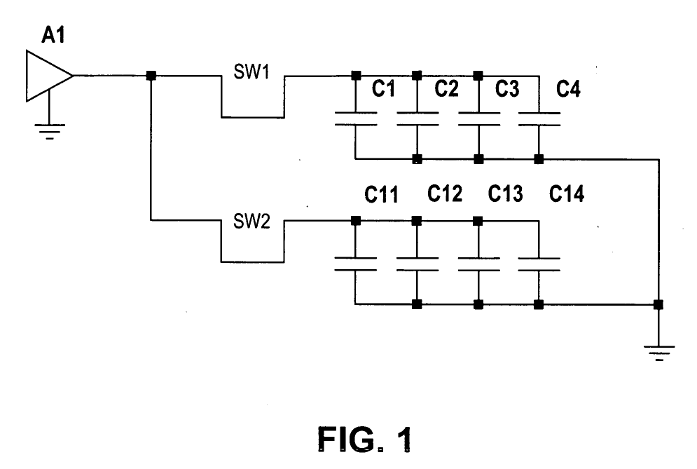

FIG. 1 shows a single signal line driving multiple devices that are divided into groups, according to an embodiment of the invention. In the illustrated example, a signal driver A1 drives a signal onto a signal line that is coupled to eight memory devices. The amount of capacitive loading produced by the input of each memory device is indicated as ‘C’, with the individual capacitive loadings labeled C1-C4 and C11-C14. In this example, the eight memory devices are organized into two groups of four devices each, and an electronic switch (SW1 or SW2) is placed between signal driver A1 and each associated group of four devices. If data is being communicated to/from a device in a particular group, the associated switch may be turned ‘on’ to permit bidirectional data transfer. At the same time, the other switch may be turned ‘off’ to electrically isolate the inactive group, thus preventing the capacitive loading from that group from effecting the signals to/from the active group. This also prevents any signals from reaching the inactive group, but since no device in that group is being used, this absence of signals does not matter.

For simplicity of illustration, only a single signal line and only two groups of four devices each are shown. However, any feasible number of signal lines, any feasible number of groups, and any feasible number of devices per group may be handled in this manner. Further, the number of devices per group does not have to be the same for each group. The amount of capacitive loading at the input of each device and the desired data transfer rate, as well as the loading produced by each switch, may all be considered when configuring this system. Using a field effect transistor (FET) for each switch, with its associated high impedance in the ‘off’ state, may make the number of groups that can be handled in this manner quite large.

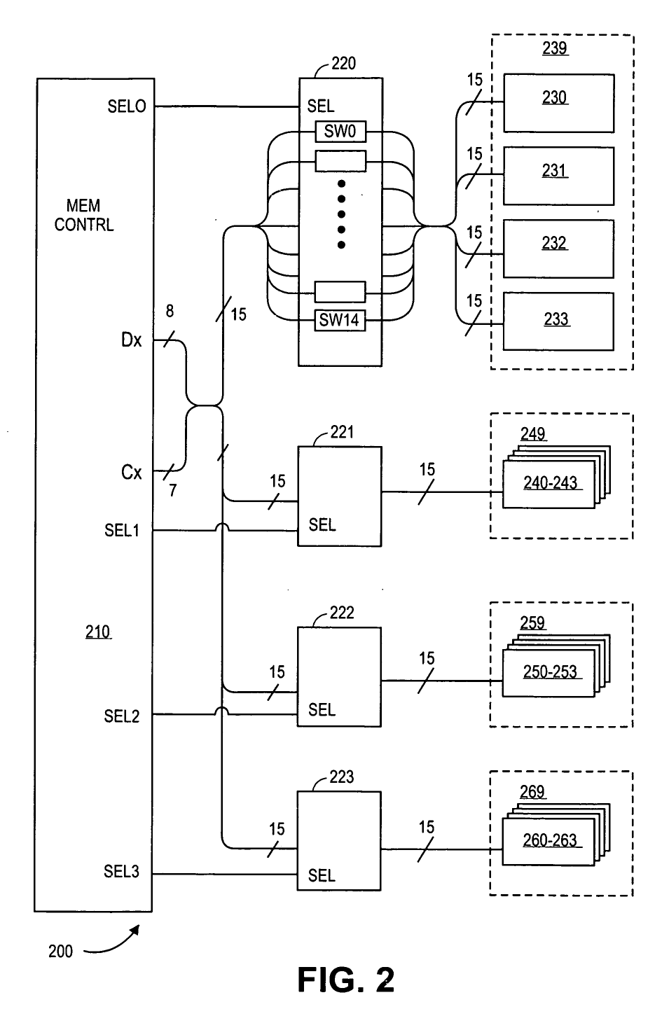

FIG. 2 shows a block diagram of a storage device, according to an embodiment of the invention. In the illustrated embodiment, storage device 200 comprises a memory controller 210, multiple switch blocks 220-223, and multiple memory devices 230-233, 240-243, 250-253, and 260-263. The memory devices are shown as organized into four different groups 239, 249, 259, and 269, with each group containing four memory devices, but other quantities of groups and memory devices per group may also be used. In some embodiments, each group may contain no more than five memory devices before capacitive loading become detrimental, but other embodiments may differ. Within the context of this document, a switch block comprises multiple electronic switches that are associated with a particular group of memory devices. The term ‘block’ does not imply that these switches must be physically located together, but merely means that these switches are functionally related because they serve the same group of memory devices.

As shown, all the memory devices in each group may be connected to a particular switch block-containing multiple switches (e.g., switches SW0-SW14 in switch block 220). To reduce clutter in the drawing, switch blocks 221, 222, and 223 are shown with a simplified illustration but are assumed to be similar to switch block 220. In the same way, groups 249, 259, and 269 are shown with a simplified illustration but are assumed to be similar to group 239. The number of memory devices does not necessarily have to be the same for each group, although making them the same may simplify other aspects of addressing and circuitry.

The memory devices within each group are shown connected together in a parallel bus arrangement. Within the context of this document, ‘connected in a parallel bus arrangement’ means that each signal pin on a device is connected to the same signal pin on the other devices in the group. For example, a data pin D1 on each device in a group is connected to the D1 pin of every other device in that group, so that a signal on line D1 is seen on pin D1 by every device in that group. Similarly, each group of memory devices is coupled in a parallel bus arrangement to the memory devices in the other groups and to the memory controller (‘coupled’ rather than ‘connected’ since the intervening switches allow the signals to/from a particular group to be passed through or blocked off.

Each memory device may contain an addressable memory array, and enough control logic to perform read, write, and erase operations on the memory array. In some embodiments, the control logic may also perform other functions, such as but not limited to self-test, error checking and correction, adjustment of the read reference voltage, tracking of erase blocks, internal memory configuration, etc. In other embodiments, some or all these functions may be performed partially or completely external to the memory device, for example in the memory controller. In some embodiments, the memory devices are NAND memory devices, but other embodiments may differ. Each memory device may or may not be a physically distinct component from the other memory devices, but is assumed to be separately selectable for memory operations.

The memory controller 210 may provide overall control of the storage device 200. This control may include things such as, but not limited to, 1) receiving memory requests from other devices not shown in FIG. 2, 2) issuing commands to a memory device, 3) transferring data between a memory device and a requesting device, 4) initiating memory tests, 5) assembling data read from multiple memory devices, 6) etc.

The switch blocks 220-223 may contain the electronic switches described earlier, and connect those switches between the signal lines connected to the memory controller and to the memory devices. These signal lines may be divided into data lines (for transferring commands, addresses, and data), and control lines (to tell the memory devices how to interpret the signals on the data lines). In the illustrated example, there are eight data lines (Dx) and seven control lines (Cx) coupled between the memory controller and each memory device, but other embodiments may have other quantities of either or both of these sets of lines. For example, the control lines may include lines such as, but not limited to: a command latch, an address latch, multiple chip enables (one for each memory device in a group), a read enable, a write enable, a busy indicator, and others. Each switch block may contain a separate switch for each of the data lines. In various embodiments, each switch block may also contain a separate switch for none, some, or all of the control lines (‘all’ is shown, but if the signal on a control line does not require high switching speed, it may not need the benefits of a switch and that control line may go directly to all the groups without intervening switches). Each data line may be bidirectional (an FET switch in the ‘on’ state may pass signals in either direction), while each control line may be implemented as unidirectional or bidirectional as needed. There may also be other lines between the memory controller and memory devices that are not shown in the drawing. Some of these may not have an intervening switch, because there is no requirement for a high switching speed on that line (e.g., power lines that don't switch), or because the line only connects to a single pin on a single device (e.g., a chip select line).

A separate switch block select line is shown between memory controller 210 and each switch block 220-223. A signal of the proper state on one of these select lines may turn on every switch in the associated switch block, so that the associated group of memory devices can communicate with the memory controller. Similarly, a signal of the opposite state on a select line may turn off every switch in the associated switch block, so that the associated memory devices cannot communicate with the memory controller, and so that the inputs/outputs on these associated memory devices are electrically isolated from the memory controller and from the memory devices in the other groups. By turning on the switches in the switch block connected to the specific memory device that the memory controller wants to communicate with, and turning off the switches in all the other switch blocks, only the memory devices associated with the selected switch block will contribute to the capacitive loading seen by the memory controller on the data and control lines.

A dedicated select line to each switch block is shown as the mechanism for turning on or off all the switches in the selected switch block. However, other embodiments may use other techniques, such as but not limited to: 1) using a wired-OR gate for each switch block so that a chip enable signal for any memory device in that group will turn on the associated switch block, 2) using a separate selection ‘bus’ containing multiple lines seen by every switch block, with a selection decoder in each switch block to decode which switch block is being selected, 3) using a particular command on the data lines to select the proper switch block, with a command decoder in every switch block to recognize when that command has selected it. Some of these techniques may require the selected switch block to maintain its selected state after the selection signal(s) disappears, until it receives a de-selection command, receives a selection command addressed to another selection block, or times out. Other selection techniques may also be used.

The illustrated embodiments shows the memory controller, switch blocks, and memory devices as separate functional entities. In some embodiments, these may also represent separate physical entities, such as one or more integrated circuit(s) for the memory controller, different integrated circuit(s) for the switch blocks, and different integrated circuit(s) for the memory devices. But in other embodiments, one or more of these functional entities may be combined into one physical entity. The scope of the various embodiments is intended to be sufficiently broad to encompass such differing physical configurations.

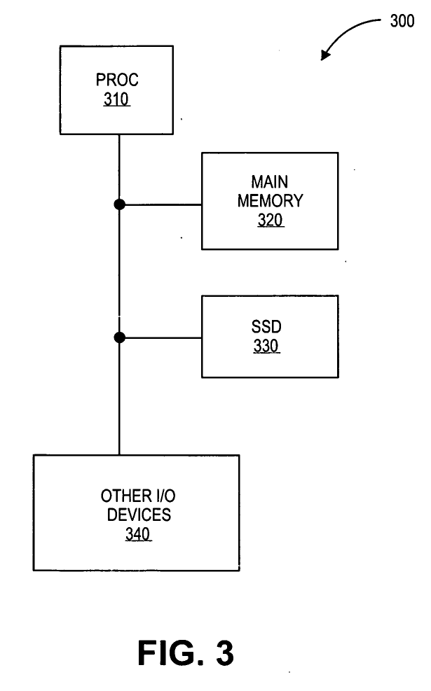

FIG. 3 shows a block diagram of a computer system, according to an embodiment of the invention. In the illustrated embodiment, the system comprises one or more processors 310, a main memory 320, a solid state disk (SSD) 330, and other input/output devices 340, all coupled together in a system. The system may also contain other devices not shown, and the illustrated devices may be coupled together in various ways. The SSD 330 may comprise the memory system depicted in FIG. 2. Requests to read data from, or write data to, the SSD 330 may come from the processor 310, from various other devices 340, or from other sources not illustrated. An SSD is shown here as the device containing the embodiments previously described, because SSD's can benefit from these techniques and are increasing in popularity at the time of this writing. However, other devices incorporating large amounts of memory may also benefit from these techniques, whether or not they resemble disk drives in command protocols, timing, data organization, or any other manner.

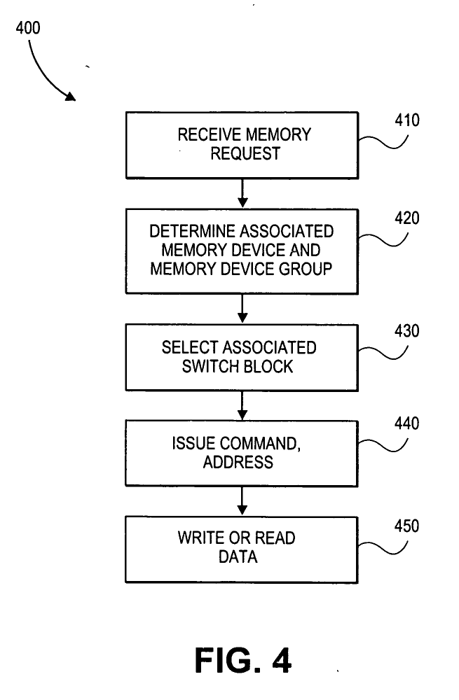

FIG. 4 shows a flow diagram of a method of operating a storage device, according to an embodiment of the invention. In the illustrated flow diagram 400, at 410 a memory controller may receive a request from another device to perform an operation on the storage device. This request may involve reading or writing data to a specific memory device within the storage device. At 420, the memory controller may determine which particular memory device is to be involved in the operation, and also determine which group (for switch selection purposes) this particular memory device is in. In some embodiments, the memory address alone may be enough to make both determinations. In other embodiments, the memory controller may have to refer to a conversion table to convert a virtual address to the corresponding physical address, and from that determine the specific memory device and group. Other techniques may also be used.

At 430 the memory controller may select the switch block associated with the proper group, thereby turning on the switches in that switch block so that the subsequent data and control line signals will be passed between the memory controller and the memory devices in that group. Similarly, the other switch blocks may be deselected, so that they are electrically isolated from the signal lines to the selected group of memory devices.

At 440, the memory controller may issue the proper command to the selected memory device, followed by the address (e.g., the starting address of a read or write operation). At 450, the memory controller may place write data on the data lines to the selected memory device, or receive read data on the data lines from the selected memory device. Within a group, a particular memory device may be selected in various ways, such as but not limited to: 1) the address indicated on the data lines may be decoded to select only one memory device. Such decoding may take place between the switch block and the memory devices, or within each memory device. 2) the memory controller may determine which memory device to select and send a selection signal to it. Other techniques may also be used. As can be seen from this description, ‘selecting’ a particular memory device may involve an active process in which one or more selection signals are sent to the memory device, or it may involve a passive process in which each memory device knows from the address whether or not it is the selected memory device.

Regardless of how the particular memory device is selected, the operation of the switch blocks may make the signals on the signal lines visible to every memory device in the selected group, but not visible to the memory devices in the other groups. More importantly, the capacitive load produced on the signal lines by the memory devices in the other groups will be isolated from the signal lines to the selected group, thus potentially improving the signal quality on the lines.

The foregoing description is intended to be illustrative and not limiting. Variations will occur to those of skill in the art. Those variations are intended to be included in the various embodiments of the invention, which are limited only by the scope of the following claims.

What is claimed is:

1. An apparatus, comprising:
a memory controller;
multiple non-volatile memory devices coupled to the memory controller and organized into multiple groups, wherein data lines for the memory devices in any particular group are connected to each other in a parallel bus arrangement; and
electronic switches to electrically couple data lines from the memory controller to equivalent data lines in each group;
wherein each of the electronic switches is to be in an ‘on’ state when a memory device in the associated group is selected for operation and in an ‘off’ state when a memory device in another group is selected for operation.

2. The apparatus of claim 1, wherein each memory device comprises a NAND non-volatile memory array.

3. The apparatus of claim 1, wherein each group contains no more than five memory devices.

4. The apparatus of claim 1, wherein the apparatus comprises a solid state disk.

5. The apparatus of claim 1, wherein the electronics switches comprise a separate electronic switch for each data line of each group.

6. The apparatus of claim 1, wherein the electronic switches are field effect transistors.

7. The apparatus of claim 1, further comprising additional electronic switches to electrically couple at least one control line from the memory controller to at least one equivalent control line in each group.

8. A method, comprising:
receiving a memory request to access a storage device, the storage device comprising multiple memory devices organized into groups;
turning on a set of switches to enable performing a memory operation on a particular memory device in a particular group of the memory devices; and
turning off other sets of switches to disable performing the memory operation on the memory devices in the other groups of memory devices.

9. The method of claim 8, wherein said turning off comprises electrically isolating capacitive loading created by the other groups of memory devices from data lines to the particular memory device.

10. The method of claim 8, further comprising performing the memory operation on the particular memory device.

11. The method of claim 8, wherein said performing is subsequent to said turning on.

12. An article comprising
a computer-readable storage medium that contains instructions, which when executed by one or more processors result in performing operations comprising:
receiving a memory request to access a storage device, the storage device comprising multiple memory devices organized into groups;
turning on a set of switches to enable performing a memory operation on a particular memory device in a particular group of the memory devices; and
turning off other sets of switches to disable performing the memory operation on the memory devices in the other groups of memory devices.

13. The article of claim 12, wherein the operation of turning off comprises electrically isolating capacitive loading created by the other groups of memory devices from data lines to the particular memory device.

14. The article of claim 12, wherein the operations further comprise performing the memory operation on the particular memory device.

15. The article of claim 14, wherein the operation of performing is subsequent to the operation of turning on.
